(19) United States
(12) Patent Application Publication
(10) Pub. No.: US 2020/0305441 A1
(43) Pub. Date: Oct. 1, 2020

(54) Pest-Repellent Compositions

(71) Applicant: Jennifer Fearon Demers, Steep Falls, ME (US)

(72) Inventor: Jennifer Fearon Demers, Steep Falls, ME (US)

(21) Appl. No.: 16/829,157

(22) Filed: Mar. 25, 2020

Related U.S. Application Data
(60) Provisional application No. 62/824,633, filed on Mar. 27, 2019.

(51) Int. Cl. A01N 65/28; A01N 65/44; A01N 31/02

(52) U.S. Cl. CPC A01N 65/28; A01N 31/02; A01N 65/44

(57) ABSTRACT

Disclosed are compositions for repelling pests, and related methods of use.

### RELATED APPLICATIONS

This application claims the benefit of priority to U.S. Provisional Application for Patent Ser. No. 62/824,633, filed Mar. 27, 2019.

### BACKGROUND OF THE INVENTION

Insects, particularly mosquitoes and ticks, carry a range of disease-causing pathogens, and are generally regarded as pests to humans, animals and plants. Indeed, worldwide every year over one million people die from mosquito-borne diseases. Mosquitoes carry many different kinds of diseases, including malaria, heartworm, dengue fever, encephalitis, yellow fever and West Nile virus.

American dog ticks are the primary vectors of Rocky Mountain spotted fever in the eastern United States. They are also known to transmit the causative agents of tularemia and canine tick paralysis. Although American dog ticks can contain the bacteria that causes Lyme disease, they seem to be unable to transmit the bacteria to humans or other hosts.

As many as 50% of adult female deer ticks (Ixodes scapularis) are infected with the bacterium which causes Lyme disease in dogs and human. Every year approximately 30,000 cases of the illness are reported to the Centers for Disease Control and Prevention (CDC).

Because of the health concerns and discomfort related to insect bites and stings, insecticides, which kill insects, or pest repellents, which merely repel insects, are commonly used to keep insects away from humans, animals, plants and building structures. However, commercially available insecticides, including those available for home use, commonly include active ingredients which are not only toxic to the target pests, but, if used in relatively confined environments and delivered as aerosol sprays, can be present in sufficient concentration to be toxic to humans and household pets. Various undesirable side effects may include immediate or delayed neurotoxic reactions and/or suffocation. The noxious odor of such materials alone can cause headaches or nausea in some individuals. These adverse side effects are exacerbated when such compositions come in contact with persons of increased sensitivity, or persons of small body mass, such as children or babies.

Therefore, efforts have been made to develop insecticidal compositions, particularly those intended for residential use in aerosol form, which are effective in killing the targeted insect pests quickly, but which are non-poisonous to humans and pets, but so far there has been only limited success.

Accordingly, there is a need for new formulations useful for effectively repelling pests, including insects, from humans, animals, plants, and loci. Additionally, effective repellents are needed to reduce the transmission of infectious diseases. Because insects are also carriers of infectious diseases, a composition that merely prevents or reduces the number of landings and bites of insects may reduce the transmission of infectious diseases.

### SUMMARY OF THE INVENTION

The invention relates to compositions for repelling pests, and related methods of use.

An aspect of the invention relates to compositions comprising a volume of an essential oil of lemon grass; a volume of an essential oil of eucalyptus; and a volume of an essential oil of tea tree.

In another aspect, the invention provides methods of repelling pests, comprising applying to an area of skin of a subject an effective amount of a composition of the invention.

In another aspect, the invention provides methods of repelling pests, comprising applying to an article of clothing an effective amount of a composition of the invention.

In another aspect, the invention provides methods of repelling pests from a locus, comprising applying to said locus an effective amount of composition of the invention.

### DETAILED DESCRIPTION OF THE INVENTION

The invention relates to compositions that are useful in repelling pests, such as insects, from target areas including but not limited to humans, animals, clothing, plants and loci.

### Compositions

The composition comprises a volume of an essential oil of lemon grass; a volume of an essential oil of eucalyptus; and a volume of an essential oil of tea tree.

In some embodiments, the ratio of the volume of the essential oil of lemon grass to the volume of the essential oil of eucalyptus is about 0.5:1. In some embodiments, the ratio of the volume of the essential oil of lemon grass to the volume of the essential oil of eucalyptus is about 1:1. In some embodiments, the ratio of the volume of the essential oil of lemon grass to the volume of the essential oil of eucalyptus is about 1.5:1. In some embodiments, the ratio of the volume of the essential oil of lemon grass to the volume of the essential oil of eucalyptus is about 2:1. In some embodiments, the ratio of the volume of the essential oil of lemon grass to the volume of the essential oil of eucalyptus is about 2.5:1. In some embodiments, the ratio of the volume of the essential oil of lemon grass to the volume of the essential oil of eucalyptus is about 3:1. In some embodiments, the ratio of the volume of the essential oil of lemon grass to the volume of the essential oil of eucalyptus is about 3.5:1. In some embodiments, the ratio of the volume of the essential oil of lemon grass to the volume of the essential oil of eucalyptus is about 4:1.

In some embodiments, the ratio of the volume of the essential oil of lemon grass to the volume of the essential oil of eucalyptus is about 1:1 to about 3:1. In some embodiments, the ratio of the volume of the essential oil of lemon grass to the volume of the essential oil of eucalyptus is about 1:1, 2:1, or 3:1.

In some embodiments, the ratio of the volume of the essential oil of eucalyptus to the volume of the essential oil of tea tree is about 0.5:1. In some embodiments, the ratio of the volume of the essential oil of eucalyptus to the volume of the essential oil of tea tree is about 1:1. In some embodiments, the ratio of the volume of the essential oil of eucalyptus to the volume of the essential oil of tea tree is about 1.5:1. In some embodiments, the ratio of the volume of the essential oil of eucalyptus to the volume of the essential oil of tea tree is about 2:1. In some embodiments, the ratio of the volume of the essential oil of eucalyptus to the volume of the essential oil of tea tree is about 2.5:1. In some embodiments, the ratio of the volume of the essential oil of eucalyptus to the volume of the essential oil of tea tree is about 3:1. In some embodiments, the ratio of the volume of the essential oil of eucalyptus to the volume of the essential oil of tea tree is about 3.5:1. In some embodiments, the ratio of the volume of the essential oil of eucalyptus to the volume of the essential oil of tea tree is about 4:1.

In some embodiments, the ratio of the volume of the essential oil of eucalyptus to the volume of the essential oil of tea tree is about 1:1, 2:1, or 3:1.

In some embodiments, the ratio of the volume of the essential oil of lemon grass to the volume of the essential oil of eucalyptus to the volume of the essential oil of tea tree is about 5:2:1. In some embodiments, the ratio of the volume of the essential oil of lemon grass to the volume of the essential oil of eucalyptus to the volume of the essential oil of tea tree is about 4.5:2:1. In some embodiments, the ratio of the volume of the essential oil of lemon grass to the volume of the essential oil of eucalyptus to the volume of the essential oil of tea tree is about 4:2:1. In some embodiments, the ratio of the volume of the essential oil of lemon grass to the volume of the essential oil of eucalyptus to the volume of the essential oil of tea tree is about 3.5:2:1. In some embodiments, the ratio of the volume of the essential oil of lemon grass to the volume of the essential oil of eucalyptus to the volume of the essential oil of tea tree is about 3:2:1. In some embodiments, the ratio of the volume of the essential oil of lemon grass to the volume of the essential oil of eucalyptus to the volume of the essential oil of tea tree is about 2.5:2:1. In some embodiments, the ratio of the volume of the essential oil of lemon grass to the volume of the essential oil of eucalyptus to the volume of the essential oil of tea tree is about 2:2:1.

In some embodiments, the ratio of the volume of the essential oil of lemon grass to the volume of the essential oil of eucalyptus to the volume of the essential oil of tea tree is about 5:1.5:1. In some embodiments, the ratio of the volume of the essential oil of lemon grass to the volume of the essential oil of eucalyptus to the volume of the essential oil of tea tree is about 4.5:1.5:1. In some embodiments, the ratio of the volume of the essential oil of lemon grass to the volume of the essential oil of eucalyptus to the volume of the essential oil of tea tree is about 4:1.5:1. In some embodiments, the ratio of the volume of the essential oil of lemon grass to the volume of the essential oil of eucalyptus to the volume of the essential oil of tea tree is about 3.5:1.5:1. In some embodiments, the ratio of the volume of the essential oil of lemon grass to the volume of the essential oil of eucalyptus to the volume of the essential oil of tea tree is about 3:1.5:1. In some embodiments, the ratio of the volume of the essential oil of lemon grass to the volume of the essential oil of eucalyptus to the volume of the essential oil of tea tree is about 2.5:1.5:1. In some embodiments, the ratio of the volume of the essential oil of lemon grass to the volume of the essential oil of eucalyptus to the volume of the essential oil of tea tree is about 2:1.5:1.

In some embodiments, the ratio of the volume of the essential oil of lemon grass to the volume of the essential oil of eucalyptus to the volume of the essential oil of tea tree is about 5:2:0.5. In some embodiments, the ratio of the volume of the essential oil of lemon grass to the volume of the essential oil of eucalyptus to the volume of the essential oil of tea tree is about 4.5:2:0.5. In some embodiments, the ratio of the volume of the essential oil of lemon grass to the volume of the essential oil of eucalyptus to the volume of the essential oil of tea tree is about 4:2:0.5. In some embodiments, the ratio of the volume of the essential oil of lemon grass to the volume of the essential oil of eucalyptus to the volume of the essential oil of tea tree is about 3.5:2:0.5. In some embodiments, the ratio of the volume of the essential oil of lemon grass to the volume of the essential oil of eucalyptus to the volume of the essential oil of tea tree is about 3:2:0.5. In some embodiments, the ratio of the volume of the essential oil of lemon grass to the volume of the essential oil of eucalyptus to the volume of the essential oil of tea tree is about 2.5:2:0.5. In some embodiments, the ratio of the volume of the essential oil of lemon grass to the volume of the essential oil of eucalyptus to the volume of the essential oil of tea tree is about 2:2:0.5.

In some embodiments, the composition further comprises a volume of one or more essential oils selected from lemon, peppermint, oregano, rosewood, juniper, lavender, and citronella. In some embodiments, the composition further comprises a volume of the essential oil of lemon. In some embodiments, the composition further comprises a volume of the essential oil of peppermint. In some embodiments, the composition further comprises a volume of the essential oil of oregano. In some embodiments, the composition further comprises a volume of the essential oil of rosewood. In some embodiments, the composition further comprises a volume of the essential oil of juniper. In some embodiments, the composition further comprises a volume of the essential oil of lavender. In some embodiments, the composition further comprises a volume of the essential oil of citronella.

In some embodiments, the composition further comprises a volume of witch hazel.

In some embodiments, the composition further comprises a volume of one or more essential oils selected from: allspice, anisum, basil, cajeput, catnip, cedar, chrysanthemum, cinnamon, citronella, clove, eucalyptus, garlic, geranium, lavender, marjoram, neem, pennyroyal, peppermint, pine, rosemary, sage, spearmint, thyme or any other members of the mint (Lamiaceae or Labiatae) family, tea-tree, vanilla, verbena or combinations thereof.

In some embodiments, the composition further comprises a volume of glycerin.

In some embodiments, the ratio of the volume of glycerin to the total volume of essential oils is about 6:1. In some embodiments, the ratio of the volume of glycerin to the total volume of essential oils is about 7:1. In some embodiments, the ratio of the volume of glycerin to the total volume of essential oils is about 8:1. In some embodiments, the ratio of the volume of glycerin to the total volume of essential oils is about 9:1. In some embodiments, the ratio of the volume of glycerin to the total volume of essential oils is about 10:1. In some embodiments, the ratio of the volume of glycerin to the total volume of essential oils is about 11:1. In some embodiments, the ratio of the volume of glycerin to the total volume of essential oils is about 12:1. In some embodiments, the ratio of the volume of glycerin to the total volume of essential oils is about 13:1. In some embodiments, the ratio of the volume of glycerin to the total volume of essential oils is about 14:1. In some embodiments, the ratio of the volume of glycerin to the total volume of essential oils is about 15:1. In some embodiments, the ratio of the volume of glycerin to the total volume of essential oils is about 16:1. In some embodiments, the ratio of the volume of glycerin to the total volume of essential oils is about 17:1. In some embodiments, the ratio of the volume of glycerin to the total volume of essential oils is about 8:1 to about 15:1. In some embodiments, the ratio of the volume of glycerin to the total volume of essential oils is about 10:1 to about 13:1. In some embodiments, the ratio of the volume of glycerin to the total volume of essential oils is about 12:1 or about 13:1.

In some embodiments, the composition further comprises a volume of water. In some embodiments, the ratio of the volume of water to the volume of glycerin is about 1:1. In some embodiments, the ratio of the volume of water to the volume of glycerin is about 1.5:1. In some embodiments, the ratio of the volume of water to the volume of glycerin is about 2:1. In some embodiments, the ratio of the volume of water to the volume of glycerin is about 2.5:1. In some embodiments, the ratio of the volume of water to the volume of glycerin is about 3:1. In some embodiments, the ratio of the volume of water to the volume of glycerin is about 3.5:1. In some embodiments, the ratio of the volume of water to the volume of glycerin is about 4:1. In some embodiments, the ratio of the volume of water to the volume of glycerin is about 2:1 to about 3:1.

In some embodiments, the ratio of the volume of water to the volume of glycerin to the total volume of essential oils is about 35:12.5:1. In some embodiments, the ratio of the volume of water to the volume of glycerin to the total volume of essential oils is about 30:12.5:1. In some embodiments, the ratio of the volume of water to the volume of glycerin to the total volume of essential oils is about 25:12.5:1. In some embodiments, the ratio of the volume of water to the volume of glycerin to the total volume of essential oils is about 20:12.5:1. In some embodiments, the ratio of the volume of water to the volume of glycerin to the total volume of essential oils is about 15:12.5:1.

In some embodiments, the ratio of the volume of water to the volume of glycerin to the total volume of essential oils is about 35:6.25:1. In some embodiments, the ratio of the volume of water to the volume of glycerin to the total volume of essential oils is about 30:6.25:1. In some embodiments, the ratio of the volume of water to the volume of glycerin to the total volume of essential oils is about 25:6.25:1. In some embodiments, the ratio of the volume of water to the volume of glycerin to the total volume of essential oils is about 20:6.25:1. In some embodiments, the ratio of the volume of water to the volume of glycerin to the total volume of essential oils is about 15:6.25:1.

In some embodiments, the ratio of the volume of water to the volume of glycerin to the total volume of essential oils is about 35:12.5:0.5. In some embodiments, the ratio of the volume of water to the volume of glycerin to the total volume of essential oils is about 30:12.5:0.5. In some embodiments, the ratio of the volume of water to the volume of glycerin to the total volume of essential oils is about 25:12.5:0.5. In some embodiments, the ratio of the volume of water to the volume of glycerin to the total volume of essential oils is about 20:12.5:0.5. In some embodiments, the ratio of the volume of water to the volume of glycerin to the total volume of essential oils is about 15:12.5:0.5.

In some embodiments, the essential oils are present in a concentration ranging from about 0.1% to about 50% by weight. In some embodiments, the essential oils are present in a concentration ranging from about 1% to about 10% by weight. In some embodiments, the essential oils are present in a concentration ranging from about 2% to about 8% by weight. In some embodiments, the essential oils are present in a concentration ranging from about 4% to about 6% by weight.

### Formulations

The compositions of the present invention may also contain one or more carriers, emulsifiers, or diluents as known to one of ordinary skill in the art. A carrier or diluent is an inert material used in making different formulations of the compositions. The specific carrier used in any composition depends on how the composition will be applied (whether in a lotion, spray or dust form, for example) and where the composition will be applied.

The compositions optionally include anti-microbial agents to reduce the transfer of infectious diseases. As one with skill in the art will understand, any anti-microbial agents appropriate for application to the specific target area to be treated may be used.

The compositions optionally include an antioxidant. The antioxidant assists in preventing rancidity of the oils and fats in the compositions. Although any suitable antioxidant may be used, rosemary extract has been found to be a suitable lipophilic antioxidant. As one with skill in the art will understand, any suitable antioxidant appropriate for application to the specific target area to be treated may be used.

The compositions optionally include a fragrance that is not an insect attractant. Such fragrances are known to one of ordinary skill in the art.

The compositions may be formulated differently based on the target area (i.e., living vs. nonliving objects) and how the compositions are to be applied.

Spray formulations are known to one of ordinary skill in the art and include aqueous solutions, water-soluble powders, emulsifiable concentrates, water miscible liquids/powders (for compositions that are soluble in water), wettable powders or water-dispersible powders, flowable/sprayable suspensions or suspension concentrates, and oil solutions.

One spray formulation of the invention is an emulsifiable concentrate. In an emulsifiable concentrate, a concentrated organic solvent-based solution of the composition (or the composition alone if it is a liquid at room temperature) is added to an emulsifier. As used herein, an emulsifier is a detergent-like (surfactant) material that allows microscopically small oil droplets to be suspended in water to form an emulsion. The concentrate is thereby dispersed evenly throughout an aqueous solution and generally remains suspended for an extended period of time (in some cases for days).

Emulsifiers useful in the invention are generally known to one of ordinary skill in the art and include, but are not limited to the following: non-ionic or ionic polymers such as polyoxyethylenesorbitan monooleates (Tweens), such as Tween 20 and Tween 60; sorbitol (polysorbate 80); propylene glycol; polyethylene glycol; ethanol (ethyl alcohol); and methanol (methyl alcohol). Other surfactants that can be used as an emulsifier for pesticide formulations are the phosphate esters. Examples of commercially available phosphate ester surfactants include, but are not limited to the following: butyl phosphate; hexyl phosphate; 2-ethylhexyl phosphate; octyl phosphate; decyl phosphate; octyldecyl phosphate; mixed alkyl phosphate; hexyl polyphosphate; and octyl polyphosphate. Preferably, the emulsifier used is either plant extract, bees wax or commercial emsulfiers/surfactants such as Novomer EC-1, Ultrez 21, Pemulen TR-2NF, soaps, poloxamers, Tweens and the like). More preferably, a plant extract (e.g., plant lecithin, plant glycerin, plant waxes and glycoproteins) is used as the emulsifier if an emulsifiable concentrate of a composition of the invention is to be formulated.

Wettable powders or water-dispersible powders are also an important spray formulation. Wettable powders are known to one of ordinary skill in the art and are made by mixing the composition with a fine dust (generally clay or talc) and a wetting agent (a dry soap or detergent). This mixture is then dispersed in water before spraying. The wetting agent will act as an emulsifier in the aqueous solution and cause the otherwise insoluble composition to dissolve in water.

Flowable/sprayable suspensions or suspension concentrates are another method of creating a spray formulation with a composition of the invention that is insoluble in water. As used herein, a flowable/sprayable suspension is a suspension of very finely ground dust diluent and composition of the invention in a non-solvent liquid (generally water). The suspension will then mix well with water and can be sprayed.

An oil solution is another method of creating a spray formulation with a composition of the invention that is insoluble in water. Such oil solutions are known to one of ordinary skill in the art. The composition is dispersed in oil and applied as an oil-based spray. This formulation is convenient for ready-to-use pesticides where further handling by the user is not desired.

Dust formulations are also known to one of ordinary skill in the art and can be utilized in formulations of the compositions of the present invention. In a dust formulation, the composition is mixed with a solid particulate diluent (preferably one with a size range of 50-100 μm). The dust formulation is then mixed with the air through the aid of a dusting machine. Preferred diluents for use in dust formulations are silicon dioxide, zinc oxide, talc, diatomaceous earth, clays, calcium carbonate, wheat flour, and powdered nut hulls.

The compositions of the invention can also be formulated into granular formulations as known to one of ordinary skill in the art. Granules, such as small pellets (usually 0.3-1.3 mm) of an inert carrier (usually clay), can be mixed with the compositions to give the desired concentration. Granules can be formulated to allow a rapid release, or an extended release of the composition of the invention.

The compositions of the invention can also be formulated into aerosol formulations as known to one of ordinary skill in the art. In order to use an aerosol formulation, the composition must be soluble in a pressurized, volatile, petroleum solvent. Upon application of the aerosol formulation, the solvent evaporates leaving micro-droplets of the composition suspended in the air.

In some embodiments, the composition may be formulated for topical application. In some embodiments, the composition is formulated as solutions, gels, ointments, creams, suspensions, etc. as are well-known in the art. Alternatively, a plastic squeeze bottle with an aperture or opening dimensioned to aerosolize an aerosol formulation by forming a spray when squeezed is used. The compositions of the invention can also be formulated into a lotion The lotion compositions can be presented as a solution or a suspension of the composition in a liquid medium.

The compositions can also be combined with a sunscreen or tanning solution. The sunscreen or tanning solution may be of the usual formulations, such as a lotion, spray or aerosol.

Various formulations of the composition may also be combined with an insecticide, such as DEET. Thus, the insecticide kills any insects that are not repelled by the composition. Other acceptable insecticides for application to animals or humans, or to other target areas are commonly known to one of ordinary skill in the art and may be included in the compositions of the present invention. Due to the effective repellency of the compositions, lower amounts of DEET are needed than are traditionally used. Embodiments of the composition may include but are not limited to 0.1%-15% DEET, 1%-15% DEET or 2-15% DEET (w/w).

The compositions may also include antimicrobial agents to further reduce the incidence of spreading infectious diseases.

### Methods of Use

The present invention provides compositions that are useful for repelling pests.

Accordingly, in certain embodiments, the invention is directed to a method of repelling pests, comprising applying to an area of skin of a subject an effective amount of a composition of the invention.

In some embodiments, the subject is a mammal. In some embodiments, the subject is a primate, canine, ovine, feline, equine, or bovine. In some embodiments, the subject is a human.

In certain embodiments, the invention is directed to a method of repelling pests, comprising applying to an article of clothing an effective amount of a composition of the invention. In some embodiments, the article of clothing is a coat, shirt, t-shirt, pants, hat, sock, mitten, or glove. In some embodiments, the article of clothing comprises wool, cotton, spandex, or Lycra. In some embodiments, the article of clothing is bug-repellent. In some embodiments, the article of clothing is water-repellent.

In certain embodiments, the invention is directed to a method of repelling pests from a locus, comprising applying to said locus an effective amount of composition of the invention. In some embodiments, the locus is terrestrial. In some embodiments, the locus is an article configured to protect a plant. In some embodiments, the locus is an article worn by or configured to protect an animal. In some embodiments, the animal is a mammal. In some embodiments, the animal is a primate, canine, ovine, feline, equine, or bovine. In some embodiments, the animal is a human. In some embodiments, the locus is a dwelling structure. In some embodiments, the locus is a body of water. In some embodiments, the body of water is a standing body of water.

In some embodiments, the pests are insects. In some embodiments, the pests are mosquitoes. In some embodiments, the pests are ticks. In some embodiments, pests are black flies.

### Application

The formulated composition can either be applied directly or can be diluted further before application. The diluent depends on the specific treatment to be accomplished, and the method of application. For example, a composition of the invention that is to be applied to trees could be diluted further with water to make it easier and more efficient to spray with known spraying techniques. Sprays and lotions may be employed for application to skin or fur of humans or animals.

Compositions, either diluted or undiluted, can be applied in a number of different ways. For small-scale application of a liquid composition, backpack tanks, hand-held wands, spray bottles, or aerosol cans can be utilized. For somewhat larger scale application of liquid compositions, tractor drawn rigs with booms, tractor drawn mist blowers, airplanes or helicopters equipped for spraying, or fogging sprayers can all be utilized. Small-scale application of solid formulations can be accomplished in a number of different ways, examples of which are: shaking product directly from the container or gravity-application by human powered fertilizer spreader. Large-scale application of solid formulations can be accomplished by gravity fed tractor drawn applicators, or similar devices.

Various formulations of the compositions of the invention can be combined with slow-release systems including micro-beads, silicon-based formulas, encapsulation, etc. to extend the repellent time. The formulations can be so constituted that they release the active ingredient only or preferably in a particular location, possibly over a period of time (i.e., a sustained-release formulation). Such combinations provide yet a further mechanism for controlling release kinetics. The coatings, envelopes, and protective matrices may be made, for example, from polymeric substances or waxes and the pharmaceutically acceptable.

Compositions of the invention may be applied as frequently as needed, based on the characteristics of the target area and the nature and concentration of the target pests to be repelled.

### Definitions

The articles “a” and “an” are used herein to refer to one or to more than one (i.e., to at least one) of the grammatical object of the article. By way of example, “an element” means one element or more than one element.

As used herein, a “subject” refers to a living animal. In various embodiments, a subject is a mammal. In various embodiments, a subject is a non-human mammal, including, without limitation, a mouse, rat, hamster, guinea pig, rabbit, sheep, goat, cat, dog, pig, horse, cow, or non-human primate. In certain embodiments, the subject is a human.

As used herein, the phrase “effective amount” refers to any amount that is sufficient to achieve a desired biological effect.

The term “repel,” as used herein, means that less time or no time is spent in a target area than in a non-target area. Thus, to repel a pest means deterring the pest from remaining in a target area. “Repel” may also include killing the target pest. “Repel” may also be used to refer to slowing the behavior and/or responsiveness of a pest so that the presence of the pest is less of a nuisance to the target area. “Repel” also includes minimizing the landings of the pest on a target area. “Repel” means reduce by an objectively measureable amount or degree compared to control. In one embodiment, repel means reduce by at least a statistically significant amount compared to control. In one embodiment, repel means reduce by at least 5 percent compared to control. In various individual embodiments, repel means reduce by at least 10, 15, 20, 25, 30, 33, 40, 50, 60, 67, 70, 75, 80, 90, 95, or 99 percent compared to control.

As used herein, target areas include, but are not limited to, areas on humans, animals, birds, plants, crops, trees, soils, fields, greenhouses, barns granaries, homes, decks, pools, buildings, clothing, tents, shoes, boots, blankets, sleeping bags, backpacks, table cloths, picnic tables and the like. Animals include but are not limited to domestic animals, farm animals, wild animals, pets, and zoo animals.

As used herein, “pest” generally includes, but is not limited to, biting, sucking and chewing insects. “Target pest” includes, but is not limited to, mosquitoes, flies (including house, barn, face, bush, and the like), black flies, no see'ums, deer flies, horse flies, beetles, gnats, ticks, beer bugs (raspberry beetles), fleas, lice, bed bugs, earwigs, ants, cockroaches, aphids, spruce bud worm, corn borers, sandfleas, tsetse flies, mites, assassin bugs and the like.

### EXAMPLES

Nomenclature: EO: essential oil; tbl: tablespoon; tsp: teaspoon

### Example 1: Evaluation of Pest Repelling Properties of Composition 1

Composition 1: lemon EO 10 drops; rosemary EO 10 drops; tea tree EO 20 drops; witch hazel 1 tbl; vitamin E oil 1 tsp; water 4 oz.

Subjects: adult dog treated and adult dog untreated (control)

Application: sprayed on hands, then rubbed on dog's fur

Scent: strong herbal/tea tree scent, long lasting

Observations: Steep Falls, Maine; April; approx. 4:30 pm; approx. 49° F.; one-hour nature walk in a forest; no ticks present on treated dog after walk in deep woods; ticks were found on control dog; no ticks were found. No flying insects noticed.

### Example 2: Evaluation of Pest Repelling Properties of Composition 2

Composition 2: lemon EO 10 drops; rosemary EO 10 drops; cedar wood EO 20 drops; basil EO 10 drops; witch hazel 1 tbl; vitamin E oil 1 tsp; water 4 oz.

Subjects: adult dog treated and adult dog untreated (control)

Application: sprayed on hands, then rubbed on dog's fur

Scent: cedar wood predominates

Observations: Steep Falls, Me.; April; approx. 4:15 pm; approx. 57° F.; one-hour nature walk in a forest; no ticks present on treated dog after walk in deep woods; ticks were found on control dog; no ticks were found. No flying insects noticed.

### Example 3: Evaluation of Pest Repelling Properties of Composition 3

Composition 3: lemon EO 10 drops; peppermint EO 10 drops; cedar wood EO 20 drops; grapefruit EO 10 drops; witch hazel 1 tbl; vitamin E oil 1 tsp; water 4 oz.

Subjects: adult dog treated; adult human male and female treated; adult cat untreated (control)

Application: sprayed on hands, then rubbed on dog's fur; sprayed directly on clothes of adult humans

Scent: very strong smell of cedar wood and peppermint

Observations: Steep Falls, Me.; April; approx. 5:00 pm; approx. 69° F.; one-hour nature walk in a forest; dog sneezed throughout the walk, and adult human female had watery eyes. No ticks found on adult dog, or human male or female. Ticks found on adult male cat. No flying insects present that day.

### Example 4: Evaluation of Pest Repelling Properties of Composition 4

Composition 4: oregano EO 20 drops; rosewood EO 10 drops; juniper EO 10 drops; lavender EO 20 drops; citronella EO 10 drops; tea tree EO 5 drops; witch hazel 1 tbl; water 4 oz.

Subjects: adult dog treated; human male and female treated; adult dog untreated (control)

Application: sprayed on hands, then rubbed on dog's fur; sprayed directly on clothes of adult humans

Scent: strong scent of lavender and oregano

Observations: Steep Falls, Me.; April; approx. 4:00 pm; approx. 49° F.; one-hour nature walk in a forest; no ticks found on adult dog, or human male or female. Ticks found on control dog. Some flying insects noticed (mosquitos and black flies).

### Example 5: Evaluation of Pest Repelling Properties of Composition 5

Composition 5: lemon grass EO 5 drops; eucalyptus EO 20 drops; tea tree EO 10 drops; witch hazel 2 tbl; water 4 oz.

Subjects: adult dog treated; human male and female treated; adult dog untreated (control); adult human male and female; child treated; cat untreated (control)

Application: sprayed on hands, then rubbed on dog's fur; sprayed on clothes, skin and hair of adult humans and child.

Scent: mild lemon grass scent, with strong tea tree smell, and witch hazel odor was evident as well; smell was long lasting and found unpleasant to some

Observations: Steep Falls, Me.; May; approx. 4:15 pm; approx. 90° F.; one-hour nature walk in a forest; mosquitoes and black flies present on the path; mosquitos noticed, flying around heads of both dog and humans, none landed; went back outside 1 hour after initial application and mosquitos landed on humans to feed. No ticks were found on adult human male/female or child; no bites from mosquitoes or black flies. Untreated cat had bites around his ears from either mosquitoes or black flies, no ticks found.

### Example 6: Evaluation of Pest Repelling Properties of Composition 6

Composition: lemon grass EO 20 drops; eucalyptus EO 10 drops; lemon EO 5 drops; peppermint EO 5 drops; witch hazel 2 tbl; water 4 oz.

Subjects: adult dog treated; human male and female treated; adult human male and female; child treated; cat untreated (control)

Application: sprayed on hands, then rubbed on dog's fur; sprayed on clothes, skin and hair of adult humans and child

Scent: strong peppermint scent; made dog sneeze

Observations: Steep Falls, Me.; May; approx. 5:30 pm; approx. 65° F.; one-hour nature walk in a forest; spray was applied to skin, clothing and hair of adult male/female. No spray was applied to adult dog, as peppermint scent was strong, and spray with peppermint caused excessive sneezing in adult dog. Mosquitos and black flies were abundant, seems like a big hatch happened after the rain. Mosquitos and black flies were swarming around dog, especially head area. No insects were around adult male/female. No ticks were found on adult male/female. Many bites on adult dogs face/ears, as a result of the mosquitos and black flies. 2 ticks were also found crawling on the fur of the adult dog.

### Example 7: Evaluation of Pest Repelling Properties of Composition 7

Composition 7: lemon grass EO 10 drops; eucalyptus EO 10 drops; tea tree EO 10 drops; vegetable glycerin 3 tbl; water 4 oz.

Subjects: adult dog treated; human male and female treated; adult human male and female; child treated; cat untreated (control)

Application: sprayed on hands, then rubbed on dog's fur; sprayed on clothes, skin (arms only) and hair of adult humans and child

Scent: very strong smell of tee tree with some hints of lemon grass; unpleasant to some Observations: Steep Falls, Maine; May; approx. 4:00 pm; approx. 63° F.; one-hour nature walk in a forest; abundant amount of mosquitoes present; black flies noticed. Mosquitos, black flies, and other flying pests present around kitten, but none around human adult male/female, child, and adult dog. Cat rapidly swarmed by many flying insects, turned around and went back inside. 1 hour later after initial application, mosquitos and black flies buzzed around humans and dog but did not land. No bites or ticks were found on adult female, adult dog, or girl child. Adult male had 0 bites on arms/head, but legs had numerous bites, and 3 ticks were found on ankle. Kitten had many small bites on his ears from brief exposure to elements.

### Example 8: Evaluation of Pest Repelling Properties of Composition 8

Composition 8: eucalyptus EO 40 drops; tea tree EO 10 drops; lemon grass EO 40 drops; vegetable glycerin 3 tbl; water 4 oz.

Scent: pleasant

Trial #1

Subjects: adult dog treated; cats treated; adult human male and female treated; children treated; adult human male untreated (control)

Application: sprayed on hands, then rubbed on dog's fur; sprayed on clothes, skin and hair of adult humans and child

Observations: Steep Falls, Me.; May; approx. 4:30 pm; approx. 70° F.; one-hour nature walk in a forest; mosquitos, black flies and many flying pests were seen around untreated male, was having to constantly swat away from face. After 1 hour in the woods, no bites or ticks found on all treated subjects. Untreated human had many large bites on legs and neck, as well as a tick was found on ankle. Three hours after initial application the composition was still fully effective.

Trial #2

Subjects: adult human male and female treated; children treated; untreated adults and children; adult human male untreated (control)

Application: sprayed on clothes, skin and hair of subjects

Observations: Leominster, Mass.; May; approx. 8 am; approx. 86° F. Subjects were at soccer field for 6 hours; no bugs flying around; no bites from pest. Approximately 20 untreated and 15 untreated children were within 50 feet seen swatting pests, applying DEET products, and clouds of pests were around them.

Trial #3

Subjects: adult human male and female treated; children treated; adult human male untreated (control)

Application: sprayed on clothes, skin and hair of subjects

Observations: Leominster, Mass.; May; approx. 11 am; approx. 66° F. Subjects were at soccer field for 3 hours; no bugs flying around; no bites from pest. Approximately 25 untreated and 20 untreated children were within 50 feet seen swatting pests, applying DEET products, and clouds of pests were around them.

Trial #4

Subjects: adult human male and female treated; children treated; adult human male untreated (control)

Application: sprayed on clothes, skin and hair of subjects

Observations: Leominster, Mass.; June; approx. 10 am; approx. 83° F.; subjects were at soccer field for 4 hours; no bugs flying around; no bites from pest. Approximately 20 untreated and 15 untreated children were within 50 feet seen swatting pests, applying DEET products, and clouds of pests were around them.

Trial #5

Subjects: adult human male and female treated; children treated; adult human male untreated (control)

Application: sprayed on clothes, skin and hair of subjects

Observations: Leominster, Mass.; June; approx. 9 am; approx. 90° F.; subjects were at soccer field for 5 hours; no bugs flying around; no bites from pest. Approximately 30 untreated and 10 untreated children were within 50 feet seen swatting pests, applying DEET products, and clouds of pests were around them.

Trial #6

Subjects: adult human male and female treated; children treated; adult human male untreated (control)

Application: sprayed on clothes, skin and hair of subjects

Observations: Leominster, Mass.; July; approx. 10 am; approx. 79° F.; subjects were at soccer field for 4 hours; no bugs flying around; no bites from pest. Approximately 20 untreated and 10 untreated children were within 50 feet seen swatting pests, applying DEET products, and clouds of pests were around them.

Trial #7

Subjects: adult human male and female treated; children treated; adult human male untreated (control)

Application: sprayed on clothes, skin and hair of subjects

Observations: Leominster, Mass.; July; approx. 12 pm; approx. 84° F.; subjects were at soccer field for 4 hours; no bugs flying around; no bites from pest. Approximately 35 untreated and 15 untreated children were within 50 feet seen swatting pests, applying DEET products, and clouds of pests were around them.

Trial #8

Subjects: adult humans treated; dog treated; untreated humans (control)

Application: sprayed on clothes, skin and hair of adult humans

Observations: Littleton, N.H.; May; approx. 10 am; approx. 80° F.; two-hour nature hike in woods; no bugs flying around; no bites from pest. Untreated humans were seen swatting pests, and clouds of pests were around them.

Trial #9

Subjects: adult human treated; children treated; dog treated; untreated human (control)

Application: sprayed on clothes, skin and hair of adult humans

Observations: Littleton, N.H.; June; approx. 9 am; approx. 87° F.; one-hour nature walk in woods; no bugs flying around; no bites from pest. Untreated human swatting at pests.

Trial #10

Subjects: adult human treated; children treated; dogs treated

Application: sprayed on clothes, skin and hair of adult humans

Observations: Littleton, N.H.; July; approx. 10 am; approx. 73° F.; two-hour nature hike in woods; no bugs flying around; no bites from pest. Visible swarms of pests; untreated human were being bit.

Trial #11

Subjects: adult humans treated; untreated humans (control)

Application: sprayed on clothes, skin and hair of adult humans

Observations: Mascoma Lake, N.H.; July; approx. 9 am; approx. 94° F. Subjects traveled to island home in middle of lake, continued to be outside in a heavily wooded area, and swimming, boating and waterskiing for approximately 4 hours; no bugs flying around; no bites from pest; spray was reapplied at approx. 1 pm; traveled back across lake at 7 pm; no bugs flying around; no bites from pest. Untreated humans swatting pests, applying DEET products, and clouds of pests were around them.

Trial #12

Subjects: adult humans treated; untreated human (control)

Application: sprayed on clothes, skin and hair of adult humans

Observations: Quechee, Vt.; July; approx. 11 am; approx. 90° F.; two-hour nature hike in gorge, twenty-minute swim; no bugs flying around; no bites from pest. Untreated human seen swatting pests, applying DEET products, and clouds of pests were around them.

Trial #13

Subjects: adult humans treated; untreated humans (control)

Application: sprayed on clothes, skin and hair of adult humans

Observations: Quechee, Vt.; July; approx. 2 pm; approx. 85° F.; two-hour nature hike in gorge; no bugs flying around; no bites from pest. Untreated humans seen swatting pests, applying DEET products, and clouds of pests were around them. Untreated humans seen swatting pests, applying DEET products, and clouds of pests were around them.

Trial #14

Subjects: adult humans treated; untreated human (control)

Application: sprayed on clothes, skin and hair of adult humans

Observations: Lake George, N.Y.; July; approx. 5 pm; approx. 94° F.; two-hour hike; no bugs flying around; no bites from pest. Untreated human within 20 feet seen swatting pests, products, and clouds of pests were around them.

Trial #15

Subjects: adult humans treated; untreated human (control)

Application: sprayed on clothes, skin and hair of adult humans

Observations: Lake George, New York; July; approx. 10 am; approx. 80° F.; two-hour hike and swim in lake; no bugs flying around; no bites from pest. Untreated human within 20 feet seen swatting pests, products, and clouds of pests were around them.

Trial #16

Subjects: adult humans treated; untreated human (control)

Application: sprayed on clothes, skin and hair of adult humans

Observations: Lake George, New York; July; approx. 8 am; approx. 88° F.; one-hour nature hike around lake; no bugs flying around; no bites from pest. Untreated human within 20 feet seen swatting pests, products, and clouds of pests were around them.

### EQUIVALENTS

Having now fully described the present invention in some detail by way of illustration and example for purposes of clarity of understanding, it will be obvious to one of ordinary skill in the art that the same can be performed by modifying or changing the invention within a wide and equivalent range of conditions, formulations and other parameters without affecting the scope of the invention or any specific embodiment thereof, and that such modifications or changes are intended to be encompassed within the scope of the appended claims.

### INCORPORATION BY REFERENCE

All U.S. patents and U.S. and PCT published patent applications mentioned in the description above are incorporated by reference herein in their entirety.

1. A composition, comprising a volume of an essential oil of lemon grass; a volume of an essential oil of eucalyptus; and a volume of an essential oil of tea tree; wherein the composition is a liquid.

2. The composition of claim 1, wherein the ratio of the volume of the essential oil of lemon grass to the volume of the essential oil of eucalyptus is about 1:1 to about 3:1.

3. (canceled)

4. The composition of claim 1, wherein the ratio of the volume of the essential oil of eucalyptus to the volume of the essential oil of tea tree is about 1:1, 2:1, or 3:1.

5. The composition of claim 1, wherein the ratio of the volume of the essential oil of lemon grass to the volume of the essential oil of eucalyptus to the volume of the essential oil of tea tree is about 4:2:1.

6. (canceled)

7. (canceled)

8. The composition of claim 1, further comprising a volume of glycerin

9. The composition of claim 8, wherein the ratio of the volume of glycerin to the total volume of essential oils is about 8:1 to about 15:1.

10. (canceled)

11. (canceled)

12. The composition of claim 8, further comprising a volume of water.

13. The composition of claim 12, wherein the ratio of the volume of water to the volume of glycerin is about 2:1 to about 3:1.

14. The composition of claim 12, wherein the ratio of the volume of water to the volume of glycerin to the total volume of essential oils is about 25:12.5:1.

15. A method of repelling pests, comprising applying to an area of skin of a subject an effective amount of a composition of claim 1.

16. The method of claim 15, wherein the pests are insects.

17. (canceled)

18. (canceled)

19. (canceled)

20. The method of claim 15, wherein the subject is a mammal.

21. (canceled)

22. (canceled)

23. A method of repelling pests, comprising applying to an article of clothing an effective amount of a composition of claim 1.

24. (canceled)

25. (canceled)

26. (canceled)

27. (Canceled)

28. A method of repelling pests from a locus, comprising applying to said locus an effective amount of composition of claim 1.

29. The method of claim 28, wherein said locus is terrestrial.

30. The method of claim 28, wherein said locus is an article configured to protect a plant.

31. The method of claim 28, wherein said locus is an article worn by or configured to protect an animal.

32. (canceled)

33. (canceled)

34. The method of claim 28, wherein said locus is a dwelling structure.

35. The method of claim 28, wherein said locus is a body of water.

36. The method of claim 35, wherein the body of water is a standing body of water.

37. (canceled)

38. (canceled)

39. (canceled)

40. (canceled)
